(19) United States
(12) Patent Application Publication
(10) Pub. No.: US 2020/0024506 A1
(43) Pub. Date: Jan. 23, 2020

(54) BI-MODAL ANALYSIS AGENT

(71) Applicants: Simon Trudel, Calgary (CA); Abhinandan Banerjee, Calgary (CA)

(72) Inventors: Simon Trudel, Calgary (CA); Abhinandan Banerjee, Calgary (CA)

(73) Assignee: UTI Limited Partnership

(21) Appl. No.: 16/515,782

(22) Filed: Jul. 18, 2019

Related U.S. Application Data
(60) Provisional application No. 62/700,678, filed on Jul. 19, 2018.

(51) Int. Cl. C09K 8/592; G01V 11/00; G01V 3/32; G01V 8/10; E21B 47/12; E21B 43/16; B82Y 30/00; B82Y 40/00

(52) U.S. Cl. CPC C09K 8/592; G01V 11/002; G01V 3/32; B82Y 40/00; E21B 47/123; E21B 43/16; B82Y 30/00; G01V 8/10

(57) ABSTRACT

Manganese oxide nanoparticles with favorable properties for multi-modal imaging in medical and non-medical imaging applications are provided. The particles are useful for multi-modal magnetic resonance imaging and fluorescence imaging. The particles are useful as T1 contrast agents in magnetic resonance imaging. The favorable properties of the manganese oxide nanoparticles also make them useful as tracers for subsurface formation characterization. One embodiment provides a process which includes the steps of injecting nanoparticles into a discrete subterranean region, and detecting fluorescence and/or magnetic data of the one or more nanoparticles in a produced fluid which includes the injected fluid and a formation fluid from the subterranean region.

### CROSS-REFERENCE TO RELATED APPLICATIONS

This application claims priority from U.S. Provisional Application No. 62/700,678, filed on Jul. 19, 2018, the entire disclosure of which is incorporated herein by reference.

### FIELD OF THE INVENTION

The invention relates to imaging reagents for medical applications and more specifically, to a manganese oxide nanoparticle with favorable properties for multi-modal imaging in magnetic resonance imaging and fluorescence imaging.

### BACKGROUND

Multi-modal imaging in medical diagnostics harnesses multiple complimentary imaging protocols for fast and accurate prognosis.¹⁻⁴ Since externally administered contrast agents are used in most medical imaging techniques, improved patient care and health-care cost reduction is possible by administering a single contrast agent capable of augmenting contrast and signal-to-noise ratio for more than one imaging modality.^{5,6} Since different imaging modalities offer different spatial and temporal resolution of anatomical features, as well as varying penetration depths and sensitivity of imaging, combining orthogonal imaging techniques by the use of multifunctional bioprobes ultimately leads to a more detailed and accurate picture of anatomical features, which in turn facilitates diagnosis.⁷⁻⁹

Among the various techniques available in the arsenal of medical imaging, the two that are most frequently combined in design of bifunctional bionanoprobes are magnetic resonance imaging (MRI) and fluorescence imaging.^{10,11} MRI, a non-invasive imaging technique, has multiple benefits, such as the use of non-ionizing radio frequencies (as opposed to X-rays), and virtually unlimited penetration depths, but suffers from relatively low sensitivity.¹² Fluorescence-based imaging, on the other hand, is a highly sensitive technique, despite having low tissue-penetration ability.^{1,13} Simultaneous use of these two imaging methodologies, however, overcomes the individual limitations associated with each technique, and is particularly useful in providing real-time guidance during surgery on delicate pathologies such as glioma, whose edges can be clearly delineated before and during the surgery.^{14,15}

Mn-enhanced MRI is an emerging subdiscipline.¹⁶⁻¹⁸ Advantages associated with Mn-based contrast agents include the use of Mn(II) which provides a paramagnetic metal center with a high S=5/2 spin state while using one of the least toxic of all essential elements;¹⁹ their propensity to act as T₁ contrast agents—by shortening the longitudinal relaxation time of water protons—resulting in a brighter signal preferred by diagnosticians;²⁰ and the possibility of using Mn-based contrast agents to detect neuronal activity and architecture in animal models without compromising the blood-brain barrier.²¹ Despite these advantages, there are very few examples of MnO-based contrast agents being used for simultaneous fluorescence and MRI detection of neoplasm. This isn't surprising, given that transition metal ions with unpaired electrons are generally recognized as fluorescence quenchers,²² and that nanostructured oxides of manganese, such as MnO₂ nanosheets, are known for their fluorophore quenching abilities via a combination of static and dynamic quenching.^{23,24} There are examples of Mn-based MR/fluorescence imaging bionanoprobes where quenching is circumvented by introducing a porous physical barrier (e.g., a silica shell) between the magnetic (MnOₓ) and fluorescent moieties; however such barriers decrease the exchange rate of water molecules, leading to reduced r₁ relaxivities.²⁵ In another example of Mn-based bifunctional contrast agents, the synthesis of protoporphyrin IX-conjugated MnO nanoparticles required over three separate conjugation steps to attach the porphyrin moiety to the MnO nanoparticles.²⁶ Other examples of this class of bifunctional nanoparticulate contrast agents include Gd-doped MnCO₃ nanoparticles,²⁷ MnS-coated Mn-doped ZnS nanorods,²⁸ and cyanine 7.5 conjugated PEGylated Mn₃O₄ nanoparticles.²⁹ Strong fluorescence of poly(N-vinylpyrrolidone) and its oxidized hydrolysate has been identified.⁶⁴ U.S. Patent Publication No. 20160051708⁶⁵ describes a metal oxide nanoparticle-based MRI contrast agent with a central cavity.

There continues to be a need for development of multi-modal contrast agents.

### SUMMARY

In one aspect, there is provided a manganese oxide nanoparticle for use in characterizing medical conditions or geological formations, the nanoparticle capped with a lactam compound and/or a hydrolyzed and polymerized product thereof.

In some embodiments, the manganese oxide is MnO.

In some embodiments, the lactam compound is azetidin-2-one (β-lactam).

In some embodiments, the lactam compound is pyrrolindin-2-one (γ-lactam).

In some embodiments, the lactam compound is piperidin-2-one (δ-lactam).

In some embodiments, the lactam compound is azepan-2-one (ε-lactam).

In some embodiments, the hydrolyzed and/or polymerized product is generated via a rearrangement and formation of an oxime or via tautomerization to a lactim.

In some embodiments, the single ring lactam compound includes one or more substituents at one or more of its aliphatic carbons.

In some embodiments, the lactam compound is conjugated to a targeting moiety.

In some embodiments, the targeting moiety is conjugated to the lactam compound via a substituent on one of the aliphatic carbons of the lactam compound.

In some embodiments, the targeting moiety is an antibody, an antibody fragment, a nucleic acid, a small molecule recognized by a receptor, a protein or a peptide.

In some embodiments, the nanoparticle has an average size below about 10 nm.

In another aspect, there is provided a synthetic process for preparing a bifunctional manganese oxide nanoparticle, the process comprising: a) mixing a Mn(II) transition metal complex with a lactam compound solvent to generate a mixture; b) heating the mixture; and c) adding an anti-solvent to the mixture to precipitate the nanoparticle.

In some embodiments of the synthetic process, the Mn(II) transition metal complex is Mn(acac)₂.

In some embodiments of the synthetic process, the manganese oxide is MnO.

In some embodiments of the synthetic process, the lactam compound is azetidin-2-one (β-lactam).

In some embodiments of the synthetic process, the lactam compound is pyrrolindin-2-one (γ-lactam).

In some embodiments of the synthetic process, the lactam compound is piperidin-2-one (δ-lactam).

In some embodiments of the synthetic process, the lactam compound is azepan-2-one (ε-lactam).

In some embodiments of the synthetic process, the hydrolyzed and/or polymerized product is generated via a rearrangement and formation of an oxime or via tautomerization to a lactim.

In some embodiments of the synthetic process, the lactam compound includes one or more substituents at one or more of its aliphatic carbons.

In some embodiments of the synthetic process, the lactam compound is conjugated to a targeting moiety.

In some embodiments of the synthetic process, the targeting moiety is conjugated to the lactam compound via a substituent on one of the aliphatic carbons of the lactam compound.

In some embodiments of the synthetic process, the targeting moiety is an antibody, an antibody fragment, a nucleic acid, a small molecule recognized by a receptor, a protein or a peptide.

In another aspect, there is provided a composition comprising the nanoparticle as described herein, dispersed in a hydrophilic solvent or a hydrophobic solvent.

In another aspect, there is provided a composition comprising the nanoparticle as described herein, dispersed in a hydrophilic solvent.

In another aspect, there is provided a process for characterizing one or more subterranean regions comprising: injecting a nanoparticle as described herein into one or more discrete subterranean regions, and detecting fluorescence and/or magnetism of the nanoparticle in produced fluid, wherein the produced fluid comprises the injected fluid and a formation fluid from one or multiple subterranean regions.

In some embodiments of the process, the nanoparticle comprises a different fluorescent agent or a different combination of fluorescent agents.

In some embodiments of the process, the process further comprises dispersing an aqueous suspension of the nanoparticle in a drilling fluid, a fracturing fluid, or an injection fluid prior to the injecting step.

In some embodiments of the process, the detecting step comprises optically detecting the nanoparticle in the produced fluid using an in-flow fluorescent measurement technique.

In some embodiments of the process, the optically detecting step is performed via photometer, fluorometer, spectrofluorometer, Raman spectrometer or a combination thereof.

In some embodiments, magnetic properties are measured using ballistic methods, magnetometric methods, electrodynamic methods, induction methods, ponderomotive methods, bridge methods, pontentiometric methods, calorimetry, neutron-diffraction methods or resonance methods.

In some embodiments of the process, the fluorescence is detected at a rate of at least once every 30 seconds.

In some embodiments of the process, the process further comprises calculating subterranean characteristics from the fluorescence.

In some embodiments of the process, the nanoparticles are adhered to proppant particles or chemicals.

In some embodiments of the process, the proppant particles are sand, silicates, resins, surfactants, or ceramics.

In some embodiments of the process, the chemicals are used during stimulation, completion, and production.

In some embodiments of the process, the detecting step provides data that permits quantification of breakthrough, or quantification of stage-specific hydrocarbon production, or a combination thereof.

In another aspect, there is provided a process for determining a property of a subsurface formation, the process comprising: injecting a fluid comprising the nanoparticle described herein into the subsurface formation; applying a variable magnetic field to the subsurface formation; detecting a magnetic response signal from the subsurface formation; and processing the magnetic response signal to obtain a property of the subsurface formation.

In some embodiments, the applying and detecting steps occur before the injecting step, and the magnetic response signal of the subsurface formation is processed to obtain a reference property of the subsurface formation.

In some embodiments, the applying and detecting steps occur after the injecting step, and the magnetic response signal of the plurality of superparamagnetic particles is processed to obtain a sample property of the subsurface formation.

In some embodiments, processing the magnetic response signal comprises comparing the reference property of the subsurface formation to the sample property of the subsurface formation.

In some embodiments, the applying, detecting, and processing steps are performed at several time points to determine a change in the property of the subsurface formation over time.

In some embodiments, the fluid is injected into the subsurface formation from a wellbore and the variable magnetic field is applied to the subsurface formation from the same wellbore.

In some embodiments, the fluid is injected into the subsurface formation from a wellbore and the variable magnetic field is applied from a different wellbore.

In some embodiments, the variable magnetic field applied to the subsurface formation is supplied by a logging tool that is inserted into the subsurface formation.

In some embodiments, processing the magnetic response signal comprises determining the concentration, spatial resolution, penetration depth, or combinations thereof, of the plurality of paramagnetic particles in the subsurface formation.

In some embodiments, the property of the subsurface formation comprises porosity, solid content, water content, fluid content, fluid composition, hydrocarbon location, hydrocarbon content, contaminant location, contaminant content, permeability, or combinations thereof.

In some embodiments, the property of the subsurface formation comprises presence, location, distribution, evolution, or combinations thereof of a target reservoir rock, a target fluid, an oil/water interface, a fracture, or combinations thereof.

In some embodiments, processing the magnetic response signal comprises mapping the presence, location, distribution, evolution, or combinations thereof of a target reservoir rock, a target fluid, an oil/water interface, a fracture, or combinations thereof.

### BRIEF DESCRIPTION OF THE DRAWINGS

FIG. 1 is a scheme for synthesis of pyrrolidin-2-one capped nanoparticles.

FIG. 2A is a transmission electron microscopy (TEM) image of pyrrolidin-2-one capped nanoparticles synthesized in pyrrolidin-2-one.

FIG. 2B is a TEM image of pyrrolidin-2-one capped nanoparticles synthesized in dibenzyl ether/pyrrolidin-2-one at a temperature equal to or greater than 250° C.

FIG. 3A is a representative TEM image of pyrrolidin-2-one capped nanoparticles.

FIG. 3B is the size distribution of the pyrrolidin-2-one capped nanoparticles of FIG. 3A.

FIG. 3C is a powder x-ray diffraction (PXRD) pattern identifying cubic MnO (bars represent the JCPDS 07-0230 pattern) as the main phase, with Mn₃O₄ as a minor impurity.

FIG. 3D is an attenuated total reflection Fourier transform infrared (ATR-FTIR) spectrum of neat 2-pyrrolidone and pyrrolidin-2-one capped nanoparticles.

FIG. 3E is an M(H) magnetometry plot of pyrrolidin-2-one capped nanoparticles.

FIG. 3F is an M(T) magnetometry plot of pyrrolidin-2-one capped nanoparticles, showing paramagnetic behavior at room temperature. The inset highlights the low-T region.

FIG. 4 is a plot of the temporal evolution of the temporal evolution of the zeta-potential of MnO-pyrrolidin-2-one nanoparticles in water at pH=7.4.

FIG. 5A shows T₁-weighted phantom images of MnO-pyrrolidin-2-one nanoparticles in water at various nanoparticle concentrations (B₀=9.4 T).

FIG. 5B is a plot of measured relaxation rates fit to equation 1, showing r₁=2.2±0.1 mM⁻¹·s⁻¹, r₂=19.1±2.5 mM⁻¹·s⁻¹, and r₂/r₁=8.6 (B₀=9.4 T).

FIG. 6A shows UV-visible spectra of pyrrolidin-2-one after reflux, and pyrrolidin-2-one capped nanoparticles, both in MeOH.

FIG. 6B shows excitation (λₑₘ=375 nm) and emission (λ_{excit}=310 nm) spectra of pyrrolidin-2-one after reflux, and pyrrolidin-2-one capped nanoparticles, both in MeOH. The slit width is 2.5 nm.

FIG. 7 shows the mass spectrometric plot of post-synthesis pyrrolidin-2-one isolated from the reaction mixture. From top to bottom, the mass spectra for separated species designated as monomer (pyrrolidin-2-one), dimer, trimer, tetramer, and pentamer are shown.

FIG. 8A is a thermogravimetry profile of the precursor Mn(acac)₂.

FIG. 8B is a thermogravimetry profile of the pyrrolidin-2-one capped nanoparticles.

FIG. 9A is a plot of cell viability of HeLa and HepG2 cells after 24 h of treatment with pyrrolidin-2-one capped nanoparticles determined by the MTT assay.

FIG. 9B shows a series of phase contrast and fluorescence micrographs of HeLa cells prior to treatment with the MnO-pyrrolidin-2-one NPs (top) and after a 24-h incubation with 10 μg/mL of pyrrolidin-2-one capped MnO nanoparticles (bottom).

### DETAILED DESCRIPTION

### Introduction and Rationale

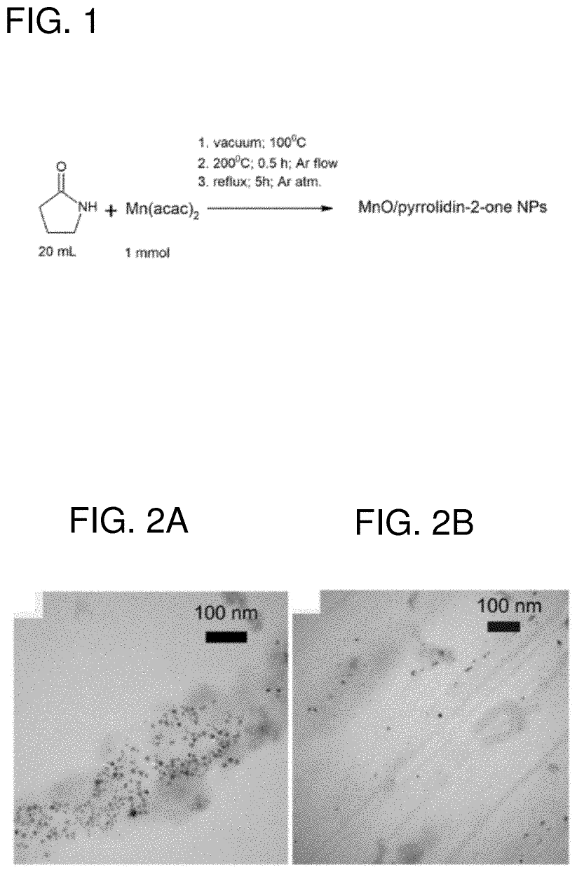

The present inventors have surprisingly found that biocompatible, water-dispersible pyrrolidin-2-one capped nanoparticles have both MRI and fluorescence imaging capabilities. These nanoparticles can be prepared in a one-step, one-pot synthesis without the need for post-synthetic functionalization or ligand exchange (see FIG. 1). The pyrrolidin-2-one structural unit is present in a variety of drugs, as well as in povidone, a water-soluble polymer made from the monomer N-vinylpyrrolidone, and used in a variety of medical formulations.³⁰ In this synthesis, pyrrolidin-2-one serves as a high-boiling solvent, as well as a capping agent that coats the nanoparticle surface.³¹

The present inventors have further recognized that the properties of these nanoparticles are particularly well suited for use as medical imaging reagents as well as non-medical applications. Among the potential non-medical applications is the use of the nanoparticles as tracers for estimating properties of subterranean formations.

The bifunctional MnO nanoparticles described herein provide a number of advantages for use as medical imaging reagents and as tracers for characterization of subsurface formations because both fluorescence and magnetic measurements may be made to assess the presence of the nanoparticles. For example, in characterization of a subsurface formation using a magnetic tracer the signal must resolved from the from the background of the formation. The present dual mode imaging allows both fluorescence and magnetism to be detected when the tracer is present. This provides a more effective measurement modality than a combination of a magnetic particle and a fluorescent particle which may have different residence times in a subsurface formation.

The same holds true for the use of a combination of a magnetic particle and a fluorescent particle in medical imaging; residence times and accumulation in tissues may be different for different particles. The dual mode imaging allows unambiguous assignment because biological tissues and subsurface formations will not provide similar backgrounds for both properties.

In developing a synthetic scheme for preparation of pyrrolidin-2-one capped nanoparticles, a literature search conducted by the inventors revealed that in 2005, Li et al.³² had decomposed Fe(acac)₃ (acac=acetylacetonate) in pyrrolidin-2-one by a straightforward reflux to generate ca. 5 nm Fe₃O₄ nanoparticles. A follow-up communication by the same group⁴⁶ clarified the role of pyrrolidin-2-one in the synthesis and indicated that hydrated FeCl₃ could also be used in place of Fe(acac)₃ as an iron precursor for the nanoparticle synthesis. None of these studies, however, considered applications of the pyrrolidin-2-one-capped Fe₃O₄ nanoparticles. In fact, further research from the same group included a secondary stabilizer for capping Fe₃O₄ nanoparticles synthesized by refluxing iron salts in pyrrolidin-2-one.⁴⁷ Other studies have replaced pyrrolidin-2-one with N-vinyl-pyrrolidin-2-one and synthesized the polymer poly(vinylpyrrolidone) in situ with Fe(acac)₃ functioning as a polymerization initiator.^{48,49} Toprak et al.'s synthesis with Mn(acac)₃ as a starting material gave a polydisperse assembly of Mn₃O₄ microclusters.³⁶

The present synthesis is inspired by the synthesis of Gao and corworkers³² yet differs in three major aspects: (a) instead of a single-step reflux, a stepwise heating protocol was used, which has been found to be effective in controlling the morphology of the MnO nanoparticles;^{50,51} (b) Mn(acac)₂ was used instead of Mn(acac)₃ as a precursor in order to minimize the formation of Mn₃O₄; (c) while the possibility that decomposition of pyrrolidin-2-one to produce azetidine and carbon monoxide may occur in this synthesis, the key step of CO reducing Fe(III) to Fe(II) ostensibly does not play a role, as the formation of MnO from Mn(acac)₂ does not require a reductive step. Omitting the stepwise heating negatively affected the nanoparticle size distribution and morphology, leading to the formation of highly polydisperse, non-uniform nanostructures. Reduction of the heating time to 1 h produced fewer nanoparticles, but the nanoparticles were not noticeably smaller or more regular in terms of size and morphology. The reflux temperature was almost exactly at the decomposition temperature of Mn(acac)₂. In a control experiment, therefore, the synthesis was repeated in a (3:1) mixture of pyrrolidin-2-one and benzyl ether, a high-boiling solvent not known for its nanoparticle-stabilizing behavior. This raised the reflux temperature of the reaction mixture by about 5° C. The MnO nanoparticles thus generated were not in any way different from the MnO nanoparticles formed in neat pyrrolidin-2-one (FIGS. 2a and 2b).

### Synthesis of Pyrrolidin-2-One Capped Nanoparticles

Manganese(II) (2,4-pentanedionate) was purchased from Strem Chemicals; pyrrolidin-2-one was obtained from Sigma Aldrich and used as received. Dimethyl sulfoxide (DMSO) was obtained from EMD, Millipore Corporation. The MnO nanoparticles were synthesized in clean oven-dried glassware using standard air-free techniques under an environment of argon. Samples of pyrrolidin-2-one capped nanoparticles were stored in sealed screw-top vials at room temperature.

In the synthesis, 253 mg (1.0 mmol) of Mn(acac)₂ was dissolved in 20 mL pyrrolidin-2-one in a three-necked flask and the mixture was heated to 105-110° C. and maintained at that temperature under vacuum for 0.5 h. The atmosphere inside the flask was exchanged with an inert gas (nitrogen or argon) three times during this period. Next, the mixture was heated to 200° C. and held at that temperature for 0.5 h under a continuous inert gas flow. Finally, the mixture was heated quickly to reflux (ca. 10° C. per minute) and maintained under reflux for 5 h under an inert gas blanket. The heating was then stopped and the system cooled to room temperature, opened to air, and ca. 200 mL (5:1) diethylether/ethanol was added to the flask. The flask was kept undisturbed overnight to precipitate out the pyrrolidin-2-one-capped MnO nanoparticles. The nanoparticles were collected via centrifugation (15 minutes, 6000 rpm), and then the supernatant discarded and re-dispersed in the same anti-solvent. This process was repeated at least three times and the nanoparticles were finally dried under air. The nanoparticles were found to be soluble in water and ethanol, but not in ether or hexane. Control reactions to test the effect of heat on neat pyrrolidin-2-one were performed in absence of Mn(acac)₂.

### Transmission Electron Microscopy (TEM)

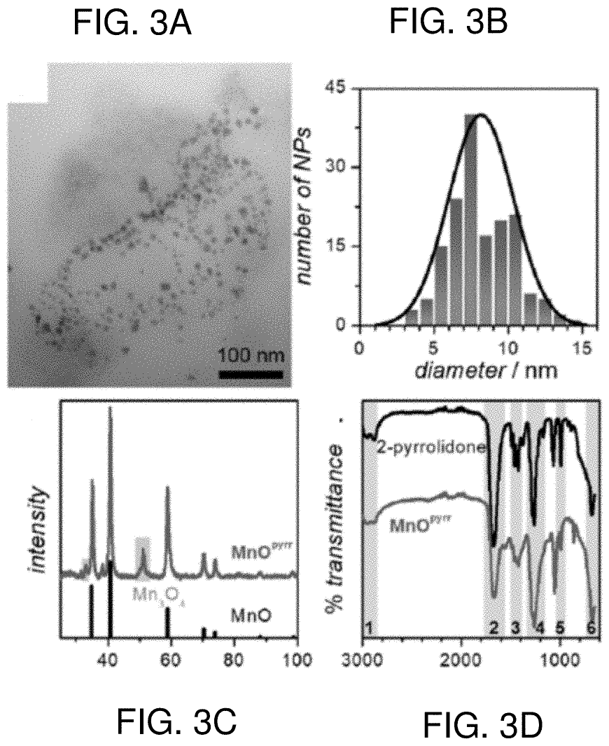

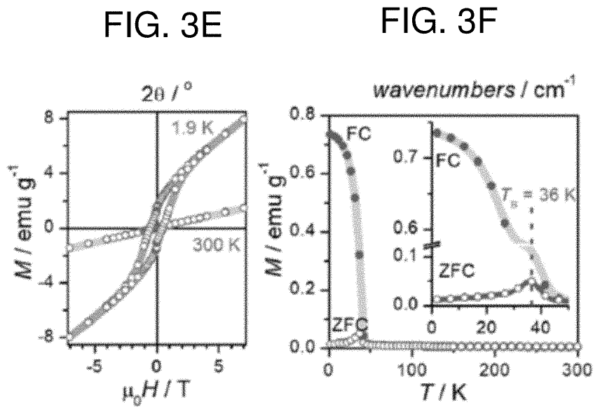

TEM imaging was performed with a Hitachi H7650 microscope operated at 100 kV. Powdered samples were dispersed in (1:1) water/ethanol, drop-cast onto a carbon-coated copper grid (Ted Pella) and left to dry in air. Images were analyzed using ImageJ.⁴⁴ The pyrrolidin-2-one capped nanoparticles were examined by TEM to assess size and morphology (FIG. 3a). Over an average of 150 nanoparticles, the mean diameter of the irregularly shaped nanoparticles was 8.1±2.3 nm (FIG. 2b). These are more polydisperse than Fe₃O₄ nanoparticles prepared in a similar way.³² This increased dispersion may be due to the smaller difference between the boiling point of pyrrolidin-2-one and the decomposition temperature of Mn(acac)₂ as compared to Fe(acac)₃, as well as other differences in the synthetic protocol.

### Powder X-Ray Diffraction (PXRD)

A Bruker D8 ECO Advance powder diffractometer (Cu Ka=1.5406 Å, 40 kV, 40 mA) was used for phase identification. The sample was suspended in ether and smeared on a zero-background silicon sample plate (Si, P-type, B-doped; MTI Corp.). Intensity was measured in the 2θ=25° to 80° range.

Powder x-ray diffraction (PXRD) (FIG. 3c) was performed to determine the phase of pyrrolidin-2-one-capped MnO nanoparticles. All but two of the observed reflections are indexed to the cubic phase of MnO (space group: Fm-3m, JCPDS: 07-0230).³³ Two minor reflections are attributed to Mn₃O₄ (space group: I4₁/amd, JCPDS: 24-0734). It was noted that foregoing the vacuum step at 100° C. during the synthesis led to an increase in the percentage of the higher-valent Mn oxides. There are previous accounts of post-synthetic oxidation of MnO nanoparticles to form, e.g., Mn₃O₄ shells. As such, observing Mn₃O₄ as a minor side-product is not entirely unexpected.^{34,35} However, given that Mn²⁺ with a d⁵ electron configuration has a maximized number of unpaired electrons, it may be expected that further oxidation would lead to reduced MRI. While the presence of a small amount of Mn₃O₄ does not appear to be detrimental, it would generally be best to avoid it.

### Attenuated Total Reflection Infrared Fourier Transform (ATR-FTIR) Spectroscopy

Infrared spectra of nanoparticles were collected on an Agilent Cary 630 FTIR spectrometer equipped with a monolithic design diamond attenuated total reflectance (ATR) accessory. FIG. 3d shows a representative ATR-FTIR spectrum of the pyrrolidin-2-one-capped MnO nanoparticles compared with the spectrum of neat pyrrolidin-2-one. Several bands are present in both spectra: (1) v_{asym}(C—H)/v_{sym}(CH) bands between 2850-2950 cm⁻¹ (2) the v(C═O) stretches at 1670 cm⁻¹ (3) the δ(C—H) deformation bands at 1381-1489 cm⁻¹; (4) the v(C—C—N)+v(C—N) stretches 1260 and 1280 cm⁻¹; (5) the ring-breathing mode of pyrrolidin-2-one at 994 cm⁻¹; and (6) the characteristic δ(N—H) out-of-plane bending vibrations of pyrrolidin-2-one at 670 cm⁻¹. The strong correspondence between the pyrrolidin-2-one-capped MnO nanoparticle sample and neat pyrrolidin-2-one confirms the presence of the stabilizing ligand on the nanoparticle surfaces.³⁶

### Zeta Potential Measurements

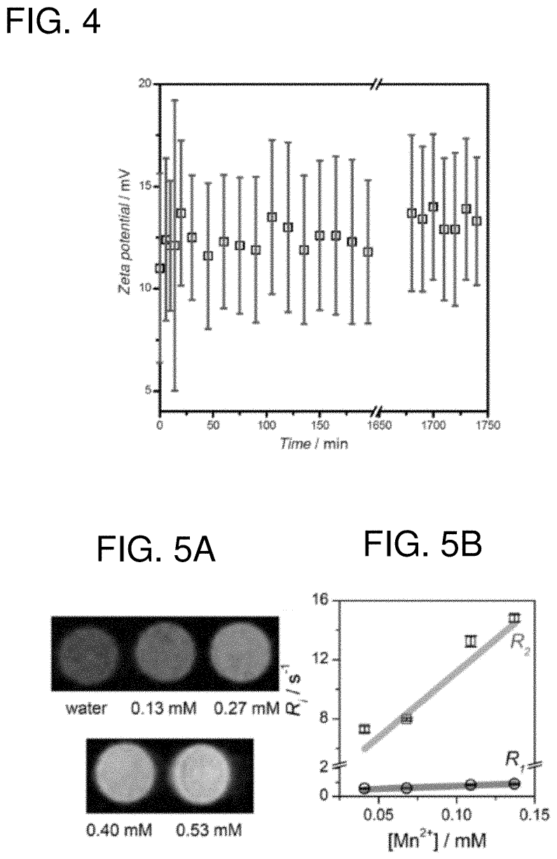

Zeta potentials of pyrrolidin-2-one-capped MnO nanoparticles in aqueous solutions were measured at pH 7.4 using disposable folded capillary zeta cells in a Malvern Zetasizer Nano ZS dynamic light scattering system. For time-dependent measurements, the cuvette remained undisturbed in the instrument for the requisite length of time. The pyrrolidin-2-one-capped MnO nanoparticles are easily dispersed in water, and show a stable zeta potential of 12.5 mV for over a period of a day (FIG. 4).

### Superconducting Quantum Interference Device (SQUID) Magnetometry

Magnetic properties of the samples were measured using a Quantum Design XL-7S MPMS SQUID magnetometer (FIGS. 3e-f). For all the magnetic measurements presented here, samples were powdered. Thus, the measured magnetic properties represent the average values for an ensemble of randomly oriented nanoparticles. Samples were prepared by placing a weighed quantity of powdered sample into a gelatin capsule, which was inserted in a clear, diamagnetic straw. M(μ₀H) measurements were conducted at temperatures of 1.9 and 300 K in a maximal field strength of 7 T. Hysteresis was observed at 1.9 K, characteristic of ferromagnetic behavior, while at 300 K a linear M(μ₀H) characteristic of a paramagnetic material was observed. The magnetization of the pyrrolidin-2-one-capped MnO nanoparticles at 7 T and T=1.9 K (ca. 8 emu/g) and 310 K (<1 emu/g) are consistent with those found in the relevant literature.^{37,38}

Zero-field-cooled (ZFC) magnetization of the sample was measured between temperatures of 1.9 and 300 K in a field of 10 mT, after the sample had been cooled in the absence of a magnetic field. Field-cooled (FC) measurements were conducted as for the ZFC measurements. However, the sample was cooled from 300 K in the presence of a 10-mT magnetic field (FIG. 3f). A blocking temperature TB is seen at ca. 36 K, indicating the transition from a low-temperature, ferromagnetic phase to a paramagnetic phase at higher temperatures. While bulk MnO is antiferromagnetic, Lee et al. reported that 5-10 nm MnO nanoparticles show ferromagnetism at low T, with a ferromagnetic-to-paramagnetic transition at 27 K,³⁹ which is similar to the present observations.

### MRI Imaging

To evaluate their potential for use as MRI contrast agents, pyrrolidin-2-one-capped MnO nanoparticles were dispersed in water and T₁ and T₂ relaxation times were measured at 9.4 T. T₂ and T₁ relaxation measurements and phantom images were also obtained using a 3.0 T system (Philips, The Netherlands). A transmit/receive radio frequency (RF) head coil was applied. A single slice multi-echo pulse sequence was used for T₂ measurements with the following parameters: repetition time (T_{R})=2000 ms, 1 average, matrix size 128×128, FOV=16 cm×16 cm, slice thickness 5 mm, 32 echoes 15 ms apart. The T₂ relaxation time was calculated using a single exponential fitting of the echo train. For T₁ measurements the inversion recovery method was used with the following parameters: slice thickness 5 mm, FOV=16×16 cm, 1 average, matrix size 128×128, T_{E}=17 ms, T_{R}=15 s, inversion time T_{I}=(25, 250, 500, 800, 1200, 1700, 2300, 3000 ms). The T₁ relaxation time was calculated using a single exponential fitting of the MR signal at different inversion times.

The relaxivity values (r₁, r₂) were determined from relaxation times measured at different concentrations from the following equation:

Tᵢ⁻¹=T_{0,i}⁻¹+rᵢC (equation 1)

where Tᵢ are the observed relaxation times in the presence of magnetic nanoparticles, T_{0,j} is the relaxation time of pure water, and C is the concentration of magnetic Mn²⁺ ions. The subscripts indicate longitudinal (i=1) or transverse (i=2) relaxivities and relaxation times, respectively.

Representative T₁-weighted images are shown in FIG. 5a, wherein the bright contrast increases with increasing concentration of MnO. The effectiveness of the pyrrolidin-2-one-capped MnO nanoparticles as a contrast agent is measured in the form of relaxivity r—the slopes of the data in FIG. 5b—which are determined by plotting the relaxation rates (Rᵢ=Tᵢ¹) as a function of Mn²⁺ concentration. The relaxivities at 3 and 9.4 T are reported in Table 1.

TABLE 1
Relaxometric Properties of Pyrrolidin-2-one-Capped MnO Nanoparticles

| B₀ (T) | r₁ (mM⁻¹ · s⁻¹) | r₂ (mM⁻¹ · s⁻¹) | r₂/r₁ |
|---|---|---|---|
| 3.0 | 2.0 ± 0.2 | 24.1 ± 6.6 | 12.1 ± 3.5 |
| 9.4 | 2.2 ± 0.1 | 19.1 ± 2.5 | 8.6 ± 1.2 |

The pyrrolidin-2-one-capped MnO nanoparticles can be used as T₁ MRI contrast agents due to their favorable r₁ values, and low r₂/r₁ ratios. This ratio is improved at high fields, mostly due to the apparent decrease in r₂. When these relaxivities are compared with those found in the relevant literature (Table 2), it can be seen the relaxivity values for pyrrolidin-2-one-capped MnO nanoparticles are comparable to those of the simpler systems such as D-glucuronic acid or human serum albumin (HSA) capped MnO nanoparticles. Moreover, post-synthetic oxidation of Mn(II) to form higher-valent oxidation states of Mn with smaller magnetic moment cannot be ruled out in these nanoparticles, given that the capping ligand is a small molecule without long, hydrophobic tails that can potentially offer some protection against such an event.

TABLE 2
Comparison of Known T₁-Weighted MRI Contrast Reagents

| | Size | r₁ | r₂ | B₀ | |
|---|---|---|---|---|---|
| Species | (nm) | (mM⁻¹ · s⁻¹) | (mM⁻¹ · s⁻¹) | (T) | Reference |
| pyrrolidin-2-one- | 8.1 | 2.2 | 19.0 | 9.4 | this work |
| capped MnO | 8.1 | 2.0 | 22.1 | 3 | |
| nanoparticles | | | | | |
| MnO-oleate- | 7 | 0.37 | 4.7 | 3 | Hyeon et |
| PEGP^{a} | 15 | 0.18 | 3.17 | 3 | al.⁵⁴ |
| | 20 | 0.13 | 4 | 3 | |
| | 25 | 0.12 | 3.67 | 3 | |
| MnO@D- | 2.5 | 7.02 | 47.97 | 1.5 | Lee et |
| glucuronic acid | | | | | al.³¹ |
| CAD/MnO^{b} | 7 | 5.42 | 31.32 | 1.5 | Haam et |
| | 17 | 1.91 | 11.59 | 1.5 | al.⁵⁶ |
| MnO@HSA^{c} | 39.2 | 1.97 | — | 3 | Huang et |
| | | | | | al.⁵⁷ |
| MnO@mSiO2^{d} | 65 | 0.99 | 11.02 | 11.7 | Gilad et |
| | | | | | al.⁵⁸ |
| Spherical MnO | 17 | 10.7 | — | 7 | Murrie et |
| | | | | | al.⁵⁹ |
| Octapod MnO | 85 | 12.5 | — | 7 | Murrie et |
| | | | | | al.⁵⁹ |
| MnO@PDn^{e} | 6-8 | 4.4 | 37.8 | 1 | Chevallier |
| | | | | | et al.⁶⁰ |
| MnO-PEG-Cy5.5^{f} | 21 | 5.73 | 40.16 | 7 | Chen et |
| | | | | | al.⁶¹ |
| MnO-TETT-FA^{g} | 16.8 | 4.83 | — | 7 | Chen et |
| | | | | | al.⁶² |
| MnO-TETT | 6.7 | 4.68 | 14.03 | 7 | Ye et al.⁶³ |

^{a}PEGP: polyethyleneglycol(PEG)-phospholipid
^{b}CAD: carboxymethyl-dextran;
^{c}HSA: human serum albumin; ^{d} mSiO₂: mesoporous silica;
^{e}PDn: PEGylated bisphosphonate dendrons
^{f}PEG-cy5.5: polyethyleneglycol(PEG)-cyanine 5.5;
^{g}TETT-FA: N-(trimethoxysilylpropyl)ethylenediamine triacetic acid-folic acid;

### Spectrophotometry and Spectrofluorimetry

UV-visible spectra of the pyrrolidin-2-one-capped MnO nanoparticles were recorded in methanol on a Cary 5E spectrophotometer in 2.5 mL quartz cuvettes, and the concentration was diluted with methanol progressively until the intensities of absorption at λₘₐₓ for both species were about 1. The spectrofluorimetry samples were then prepared by subjecting samples to a ten-fold dilution in methanol. Excitation and emission spectra were recorded on a Horiba Jobin Yvon Fluoromax-4 spectrofluorimeter with a slit width of 2.5 nm.

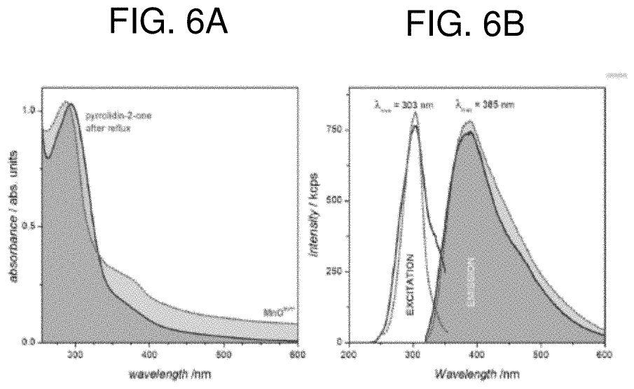

Pyrrolidin-2-one itself does not show any features in the UV-vis spectrum. However, when subjected to the same conditions used in synthesis of pyrrolidin-2-one-capped MnO nanoparticles in the absence of Mn(acac)₂, the spectrum gains a peak at 300 nm. The exact reaction is unknown but it is known that the heavier homologue of pyrrolidin-2-one, caprolactam, undergoes ring opening polymerization under an inert atmosphere at about 260° C. to produce Nylon-6.52. It is a reasonable hypothesis, therefore, that pyrrolidin-2-one, upon being heated under nitrogen, forms a luminescent oligomeric species. Furthermore, the fluorescence of amine-containing small molecules was noted to have been enhanced in the presence of an oxidant such as peroxides; MnO, too, is well-known in organic chemistry as a potent oxidation catalyst.⁵³ In the case of pyrrolidin-2-one capped MnO nanoparticles, therefore, the same UV-Vis peak persists, albeit shifted to slightly higher wavelengths, along with another, broader shoulder which can be attributed to uncapped MnO nanoparticles. These features can be seen in the spectra shown in FIG. 6a.

A fluorometric study was conducted on the pyrrolidin-2-one capped MnO nanoparticles and the pyrrolidin-2-one ligand itself after subjecting it to a control reaction in the absence of Mn(II). The results are shown in FIG. 6b where it is seen that both the unidentified, possibly oligomeric species formed upon refluxing pyrrolidin-2-one under nitrogen, as well as the pyrrolidin-2-one capped MnO nanoparticles, display photoluminescence.

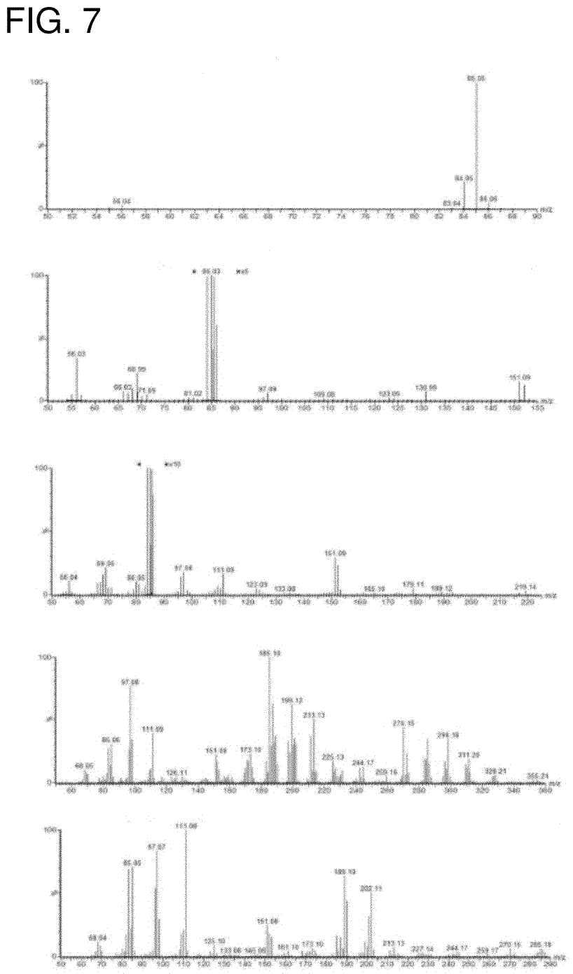

There have been recent reports of non-fluorescent monomers generating fluorescent oligo- and polymers, including pyrrolidin-2-one and its oligomers.⁴⁰⁻⁴² In nitrogen-containing polymers, N-branched amine groups are believed to be the luminogen in the oligomeric species. The oxidation of an amine group, followed by rearrangement and formation of the oxime structural motif is thought to be one of the pathways that generate photoluminescent moieties within these molecules.⁴³ Previous reports of dramatically enhanced fluorescence in PVP,⁴⁰ as well as in the hydrolysis products of N-methyl pyrrolidin-2-one, led to investigations of the photophysical properties of the pyrrolidin-2-one-capped MnO nanoparticles. The pyrrolidin-2-one-capped MnO nanoparticles have an absorbance maximum at 288 nm (FIG. 6a), optimized excitation at 303 nm, and maximal emission broadly centered at 395 nm that spans well into the visible range (FIG. 6b). As MnO is not known to be a fluorophore, this result was surprising. It was hypothesized that the luminescence could originate from the pyrrolidin-2-one capping ligand. Given pyrrolidin-2-one itself does not have strong absorbance features or luminescence, neat pyrrolidin-2-one was treated with the same temperature profile used in the synthesis of the pyrrolidin-2-one-capped MnO nanoparticles. The photophysical characteristics of pyrrolidin-2-one thus treated bear a striking similarity to the photophysical characteristics of the pyrrolidin-2-one-capped MnO nanoparticles (FIG. 6b), supporting the belief that the photophysical properties arise from by-products generated from pyrrolidin-2-one during the MnO nanoparticle synthesis, which may include, amongst others, oligomeric species (FIG. 7). This suggests that the pyrrolidin-2-one-capped MnO nanoparticles may be useful in fluorescence imaging as well. It has been pointed out that pyrrolidin-2-one is unstable upon prolonged reflux even in anoxic atmospheres.⁵⁴ It is hypothesized that pyrrolidin-2-one, upon being heated to reflux in the presence of a transition metal salt, undergoes ring-opening, followed by oligomerization and/or oxidation steps; the resultant species formed in situ are responsible for the luminescence. It is to be noted, however, that pyrrolidin-2-one, upon being heated even without a manganese salt, forms very small amounts of a luminescent species; this is in accordance with the observations made by Wang and co-workers in the context of other nitrogen-containing organic molecules and polymers.^{42,45} Although oxidative transformation of amine groups upon heating or upon contact with an oxidant has been identified as a key process in forming fluorescent centers, the exact nature of the oxidized fluorophore moieties are not clear at present.⁵⁵

### Mass Spectrometry of Pyrrolidin-2-One After the Nanoparticle Synthesis Regimen

In order to identify some of the oligomeric species that we hypothesize are generated in situ from pyrrolidin-2-one during the synthesis of MnO nanoparticles, and might be responsible for fluorescence, the pyrrolidin-2-one was isolated from the reaction mixture after the synthesis of MnO nanoparticles, separated the nanoparticles as described previously, removed all volatile organics used as antisolvents during the MnO nanoparticle precipitation, and subjected the viscous brown liquid to mass spectrometry (FIG. 7). It is to be noted that the purpose behind this mass spectrometry analysis was to confirm the formation of heavier oligomeric species with molecular ion peaks at (m/z) values approaching multiples of the molecular ion peak of the monomer, pyrrolidin-2-one, minus certain constant fragment weights, potentially attributed to small-molecule byproducts formed during oligomerization. No attempt was made to assign chemical structures to these oligomeric species solely on the basis of mass spectrometry data.

Thermogravimetry of Mn (acac)₂ and Pyrrolidin-2-One-Capped MnO Nanoparticles

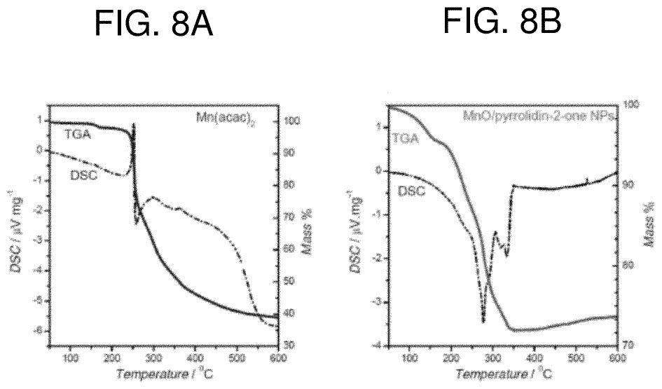

Thermogravimetry of the Mn precursor, Mn(acac)₂, as well as of the pyrrolidin-2-one-capped MnO nanoparticles, was carried out in alumina pans under a nitrogen atmosphere at a heating rate of 10 K min⁻¹ on a Netzsch STA 409 PC. The results are shown in FIGS. 8a and 8b and generally indicate conversion of the Mn(acac)₂ precursor.

### Confocal Microscopy and Cytotoxicity Study

HeLa cells exposed to 0.01 mg/mL pyrrolidin-2-one-capped MnO nanoparticles for 24 h were examined via bright field (phase contrast) and fluorescent microscopy. Microscopic observations and cell images were acquired with a Carl Zeiss microscope (Toronto, Canada) with a magnification factor of 400. Digital images were obtained with AXIOVISION software (LE64; Carl Zeiss Canada, Ltd.) and adjusted for brightness and contrast using Adobe Photoshop CS5.

HeLa and HepG2 cells were maintained in DMEM (Sigma Aldrich, St Louis, Mo., USA) supplemented with 10% fetal calf serum without antibiotics at 37° C. in a 5% CO₂ humidified incubator. The MTT colorimetric assay was performed as described previously⁴⁵ with minor modifications to assess cell metabolic activity. Briefly, cells growth in a 96-well plate (150 μL/well) were incubated with MTT (15 μL ar concentration of 5 mg/mL) for 2 h at 37° C. After three washes with PBS, the blue formazan crystal was solubilized in DMSO and the absorbance at 595 nm determined in a Beckman Coulter Multimode Detector DTX 880 microplate reader. To determine the toxicity of pyrrolidin-2-one-capped MnO nanoparticles, HeLa and HepG2 cells were grown in the presence of the indicated concentrations for 24 hours. The experiment was performed in duplicate, with two samples of pyrrolidin-2-one-capped MnO nanoparticles from different batches.

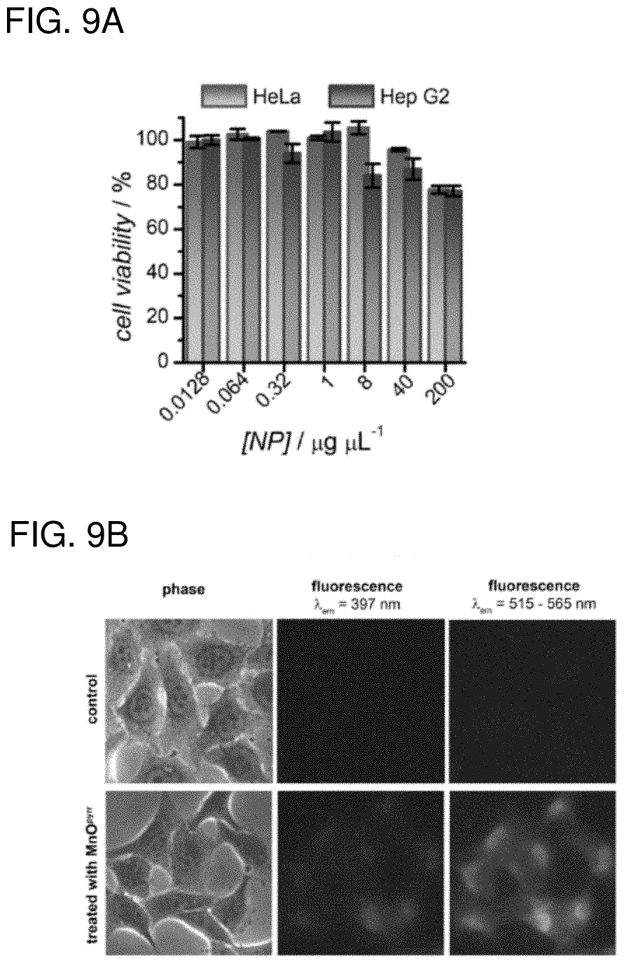

Before attempting imaging, it was confirmed by an MTT assay that the cellular toxicity of pyrrolidin-2-one-capped MnO nanoparticles in HeLa and HepG2 cells is very low. Indeed, more than 80% of cellular viability at concentrations lower than 200 mg/mL was determined (FIG. 9a), which is on the same level as other MnO nanoparticle-based contrast agents. Taking advantage of the fluorescence properties of the pyrrolidin-2-one-capped MnO nanoparticles, incorporation of these nanoparticles into HeLa cells was investigated by fluorescence microscopy. HeLa cells were treated with 0.01 mg/mL of pyrrolidin-2-one-capped MnO nanoparticles for 24 h, a concentration at which the cells are essentially all viable. Fluorescence was observed only in the treated cells using an UV filter and a green filter (FIG. 9b), indicating successful incorporation of the pyrrolidin-2-one-capped MnO nanoparticles into the cells. A control experiment examining untreated HeLa cells under otherwise identical conditions didn't show any fluorescence (FIG. 9b) Therefore, it was concluded that the pyrrolidin-2-one-capped MnO nanoparticles are active for two imaging modalities (fluorescence and MRI), with negligible cytotoxicity in the therapeutic range.

### Use of MnO Nanoparticles as Tracers of Subterranean Formations

The MnO nanoparticles described herein may be used as nanoparticle tracers. In such embodiments, the nanoparticles are injected underground into to one or more discrete and unique subterranean regions and then detected via magnetic or fluorescence detection as they flow back out of the subterranean regions in produced fluids. In some embodiments a process may further include measuring a time elapsed between injecting the nanoparticles and detecting the nanoparticles. Similar processes using different types of nanoparticles are described in PCT Publication Nos. WO2015200789 and WO2017136641, both incorporated herein by reference in entirety.^{66,67}

During the recovery of hydrocarbons with treatments including hydraulic fracturing and enhanced oil recovery, in addition to other secondary and tertiary recovery methods, underground regions can be differentiated from each other due to the type of treatment. For example, hydraulic fracturing occurs in stages, each with its own perforations and high pressure fluid treatment. Similar formation separations are present in enhanced oil recovery and other secondary and tertiary recovery methods, where regions are separated due to geological features or the presence of an injector and/or producer well, for example. In some embodiments, one or more different nanoparticles can be injected in one or more discrete subterranean regions during these hydrocarbon recovery processes. In some embodiments, a first nanoparticle as described herein including a first fluorescent agent is injected at a first discrete subterranean region and a second nanoparticle including a second fluorescent agent is injected at a second discrete subterranean region, such that the first and second nanoparticles have differentiated fluorescence emission spectra and/or magnetic properties. Any number of nanoparticles with differing fluorescence emission spectra can be injected into any number of subterranean regions. The nanoparticles can be detected in produced water, which includes both the injected fluids used during hydrocarbon recovery and the natural formation fluid, i.e. the fluid that was already in the subterranean reservoir that is released as a result of the treatment. In some embodiments, multiple different varieties of tracer nanoparticles are optically distinct enough from each other as a result of the inclusion of different fluorescent agents in the nanoparticle structure, which has an effect on the fluorescence emissions of the nanoparticle. In detection of magnetic properties, magnetization, magnetic susceptibility and fluid relaxation times may be measured. Techniques such as nuclear magnetic resonance (NMR) and magnetic resonance imaging may be used.

In some embodiments, a process of injecting the nanoparticles into a wellbore includes the placement of the nanoparticles described herein into an aqueous suspension. This aqueous suspension can comprise a solution of nanoparticles in an alcohol, e.g. ethanol, a solution of nanoparticles in water, or a solution of nanoparticles in any polar solvent. In some embodiments, when the nanoparticles are delivered to the wellbore for injection into the subterranean formation, they are mixed with drilling fluids at the wellsite. Such drilling fluids can include but are not limited to: slickwater formulations, proppant formulations, acid fracturing formulations, or emulsification formulations. The nanoparticle can be added to the one or more drilling fluids with a volume ratio of nanoparticles to total drilling fluid of 1:1, or 1:2, or 1:4, or 1:10, or 1:20, or 1:100, or 1:1000, or 1:100,000, or 1:1,000,000, or 1:10,000,000. In some embodiments, prior to injection into the subterranean formation, the nanoparticles can be dispersed in additional fluids, also referred to herein as dispersal solutions, which can include but are not limited to: polymer-stabilized solutions, solutions containing nonionic surfactants, solutions containing anionic surfactants, or solutions containing cationic surfactants. The nanoparticle can be added to the dispersal solutions with a volume ratio of nanoparticles to dispersal solution of 1:1, or 1:2, or 1:4, or 1:10, or 1:20, or 1:100, or 1:1000, or 1:100,000, or 1:1,000,000, or 1:10,000,000. The dispersal solutions enable the nanoparticles to be homogeneously mixed prior to addition with drilling fluid and subsequent injection during hydrocarbon recovery techniques. For example, the nanoparticles can be dispersed evenly throughout fluids used in hydraulic fracturing for a specific stage to ensure that the tracer is evenly distributed throughout the subterranean formation.

In some embodiments, the nanoparticles described herein are synthesized to act as passive, also known as conservative, tracers, that remain in the water phase and do not partition into the oil phase. In one embodiment, chemical group functionalization is used to modify the zeta potential of the particles in aqueous solution. Specifically, the surface of the tracer particles can be functionalized with one or multiple charge-stabilizing polymers, hydrophilic ligands, and/or zwitterionic compounds that confer colloidal stability to the tracer particles within the injected fluid. The use of these stabilizing polymers enables the particles to stay in the water phase, even in the presence of differing environmental changes such as but not limited to fluctuations in temperature, pressure, pH, and salinity. In some embodiments, these passive tracers can be used to specifically track water or aqueous fluid flow throughout one or many subterranean regions, without undergoing any conformational change, chemical change, or phase change throughout the lifetime of the hydrocarbon recovery treatment.

In some embodiments, the presence (including concentration) or absence of the nanoparticles in produced fluid is determined through fluorescence measurements, including fluorescence spectral measurements and single emission wavelength measurements. The fluorescence measurements can be taken in the range between 300 nm and 2000 nm, corresponding to the range from blue visible light to near-infrared and infrared electromagnetic spectra. The detection of the nanoparticles can occur in the produced fluid through stimulation of the produced fluid with excitation and corresponding detection of fluorescence emissions. The presence of absence of the nanoparticles in produced fluid is also determined through magnetic measurements.

Optical detection of the nanoparticles can occur either or both downhole and on the surface near the wellbore using devices that read fluorescence measurements, through the mechanism of excitation and emission spectral measurements. For downhole measurements, downhole fluorescent spectroscopy tools can be used and are currently in development by several oilfield service companies. For surface-level detection, portable fluorescent spectrometers, modified Raman spectrometers, or photometers, for example, could be utilized. In this arrangement, there are many possibilities for unique identification of the particles. One method would be to excite the sample of injection fluid with nanoparticle tracer at a characteristic wavelength and detect specific emission wavelengths via a photometer. Another method would be to multiplex and excite the sample over two or more distinct excitation wavelengths to similarly detect emission wavelengths of the sample. Additionally, another arrangement would be to excite the sample at a characteristic wavelength and record emission wavelengths over an entire range over the spectrum.

In some embodiments, the data that is generated is data regarding the absence, presence, and concentration of nanoparticle tracers in produced solution. This data is compiled using measurements of the fluorescence intensity or magnetic data of the nanoparticle in the produced fluid and correlating the fluorescence or magnetic measurements with calculated statistical models that convert the intensity of fluorescence or magnetic data to the concentration of the nanoparticle. Concentration models can be calibrated using stock solutions of known concentrations of nanoparticles in fluid, but the mechanism of creating the models correlating fluorescence and magnetism to concentration are not limited to this method of calibration. By combining this data with data regarding time at which nanoparticle tracer fluorescence is detected, multimodal, useful data for some or all possible tracer applications can be achieved. Data can be collected in real-time using the fluorescence or magnetism measurement devices that are present either in the wellbore or on the surface at the wellsite.

In some embodiments, the detection limit of the fluorescence and magnetism measurement devices and their correlated nanoparticle concentration in produced fluid is less than 1 part per trillion, or less than 1 part per billion, or less than 1 part per million, or less than 1 part per thousand. In one embodiment of the invention, the data points of fluorescence intensity are collected at a rate of 1 point per time, where the sampling time can range from 0.1 and 30 seconds. This rate of detection represents a near-continuous data collection mechanism, enabling real-time concentration calculations for the nanoparticle tracers.

In one embodiment, the nanoparticles described herein can be used during hydraulic fracturing operations of an oil or natural gas reservoir. In this application, a plurality of nanoparticle tracers may be delivered to a single fracture site or a plurality of nanoparticle tracers may be delivered to different fracture sites stemming from a single wellbore. Delivery of one or multiple nanoparticle tracers at any of the pre-treatment, treatment, and post-treatment stages may be provided. The nanoparticles can be used before a fracturing treatment and can mix with the formation fluid, or during the fracturing treatment to result in mixing with injected fluid as well as the formation fluid. The nanoparticles may also be injected after fracturing has occurred.

In some embodiments, the nanoparticles described herein may further include moieties attached to the core of the nanoparticles which feature a single peak wavelength of emission, or can feature more than one wavelength emissions peak if two or more varied fluorescent agents are used. In some embodiments of this invention, there are additional combinations of fluorescent agents that can result in differentiated fluorescence emissions based on the relative concentration of each fluorescent agent in the particle. For example, in a nanoparticle containing two or more fluorescent agents, the ratio of the amount of each fluorescent agent can result in a differentiated particle that can be distinguished from one or multiple nanoparticles containing simply one of the fluorescent agents used in the nanoparticle containing two or more fluorescent agents. These particles and the configuration of multiple fluorescent agents allow for an increase in the number of discrete nanoparticles, allowing for larger operations involving increased numbers of subterranean regions that are treated with nanoparticle tracers.

In one embodiment, the nanoparticles described herein can be used to identify a particular attribute of the reservoir formation through the calculation of the concentration of the nanoparticle in the produced fluid. In embodiments where two or more types of nanoparticles are used, each nanoparticle may be optically distinct from the other. For example, in some embodiments of the invention, nanoparticle tracers can be utilized to obtain statistics informing on production including binary data informing on breakthrough (i.e. efficacy of the fracturing treatment in one singular stage or subterranean region of the reservoir). This data can be non stage-specific data, with tracers placed in singular select stages of the overall horizontal well; due to the mixing of fluids between the stages, this data may not maintain stage specificity and the tracer concentration would potentially be less important than simply the presence or absence of the tracer in the produced fluid.

In some embodiments, the nanoparticles described herein can provide data and statistics in a stage-specific manner as a result of the injection of two or more fluorescently distinct tracers in different stages. These embodiments utilize two or more of these optically distinct particles for determination of additional reservoir attributes, and the data on the particle concentration may be analog data. This data can be used to generate statistics including but not limited to breakthrough, subterranean permeability, fracture treatment efficacy, and projected hydrocarbon production. Statistics on breakthrough are representative of the distance in which the fractures permeate the formation, and tracer concentrations calculated over time are very representative of the distance of these propagations relative to breakthrough from other stages. Permeability values may be obtained through the combination of the tracer data with known pressure data and subterranean formation characteristics, including but not limited to porosity, rock type and stress qualities, and other rock qualities. Fracture treatment efficacy may be calculated via tracer concentration and the flowback time of the tracer in the produced fluid; the quicker the tracer flowback relative to other tracers, the less effective the treatment in the stage featuring the fast-flowing tracer. Projected hydrocarbon production may be a longer-term study of the tracers as they elute from the reservoir in a steady-state fashion. Concentration of the nanoparticle tracer as it flows out of the formation throughout the fracturing process, and concentration of the tracer as it flows out of the formation after the fracturing process, can be used to determine projected production values over the course of 1 week, or 1 month, or 2 months, or 3 months, or 6 months, or 1 year.

In another embodiment, the nanoparticles described herein can be injected into different wells across a pad to characterize lateral breakthrough. In this application, nanoparticles can be injected into offset wells as well as adjoining wells during zipper fractures. The real-time absence or presence of tracer recovery can inform operations for lateral well placement and production. Statistics generated from mass tracer recovery and timescale recovery can be used to characterize lateral well connectivity and estimated production lifetime. Nanoparticles can be sampled up to 1 week, or 1 month, or 2 months, or 3 months, or 6 months, or 1 year, or 2 years, after initial well production and characterization. Mass recovery of tracer coupled with timescale from this longer-term testing can inform on absence or presence of breakthrough and if applicable, breakthrough rates of the subterranean formation.

In another embodiment of this invention, nanoparticles can be injected up to 1 week, or 1 month, or 2 months, or 3 months, or 6 months, or 1 year, or 2 years, after initial well production and characterization. Mass recovery of tracer coupled with timescale from this longer-term testing can inform on well breakthrough rates, and well and formation integrity.

In some embodiments, the lactam of the nanoparticle described herein may be provided with polymer functional groups and cross-linked with chemical functional groups, molecular additives, or other polymeric groups, rendering the particles with a new surface coating. This surface coating can alter the fluid flow characteristics of the nanoparticles in hydrophilic or hydrophobic media. These embodiments utilize two or more of these optically distinct particles for characterization of chemicals or molecular additives used during hydrocarbon production. Differential mass recovery concentrations of the tracers as well as the timescales of tracer recovery can be used to determine efficacy of various molecular additives used during production operations.

In some embodiments, the size of the MnO nanoparticle can be increased to match the diameter of proppants used during fracturing operations. These embodiments can include nanoparticles with sizes ranging up to 500 nm in diameter. At these increased sizes, nanoparticles of these embodiments can have fluid flow characteristics that match the fluid flow characteristics of select proppant additives. These embodiments utilize two or more optically distinct particles for characterization of proppant proliferation during fracturing operations. Differential mass recovery concentrations of the tracers as well as the timescales of tracer recovery can be used to determine proppant proliferation between relative sub-stages of fracturing operations and characterize proppant mobility, proppant flowback from discrete stages, and proppant stability.

In some embodiments, two or more optically different nanoparticles can be used to evaluate the efficacy of tools used during fracturing operations. In this embodiment, differential tracer recovery and timescale would enable generation of statistics to evaluate relative sub-stage or stage-specific production associated with specific tools. These tools can include diverters, frac plugs, reamers, and cutters. In one embodiment, two or more optically different nanoparticles can be used to evaluate the efficacy of a diverter used during fracturing operations. Increased or decreased tracer recovery from one stage relative to another can inform on tracer proliferation through the subterranean formation and may indicate whether the diverter was effectively deployed during an operation. In another embodiment of the invention, two or more optically different nanoparticles can be used to evaluate the efficacy of a frac plug used during fracturing operations. The binary absence or presence of recovery from one stage outfitted with a frac plug—compared both before and after tracer injection—may indicate whether a frac plug was effectively deployed during an operation. Information indicating frac plug efficacy can be used to inform on cleanout operations.

Additional statistics that can be generated from the nanoparticles include but are not limited to: overall formation permeability, calculated distance of perforations prior to the fracture treatment, extent of fracturing into the formation, fracture diameters for discrete stages, differential pressure and differential temperature between subterranean regions and intra-subterranean regions, and fluid wetting properties.

The data obtained from the absence, presence and/or concentration of tracer nanoparticles, in conjunction with other data such as chemical kinetics of the nanoparticles, diffusion of the nanoparticles into the reservoir, sorption of the nanoparticles to the subterranean formation, seismic measurements of the formation, environmental pressure, and environmental temperature of the subterranean formation can be used to determine fracture geometry as well as other statistics such as near-wellbore fracture-surface area, inter-well fracture-surface area, and fracture volume.

In addition to aforementioned passive, or single-phase, tracers that remain colloidal in the water phase, modification of chemical group functionalization to the external coating of the nanoparticles can allow for nanoparticles to serve as partitioning tracers, meaning they will selectively phase from the aqueous to the oil phase. In one embodiment of the invention, these particles make use of a varied functional group or multiple varied functional groups that can be more hydrophobic than the functional groups used in passive tracers.

In one embodiment, the partitioning ability of the aforementioned nanoparticle tracers confers higher oil-phase solubility relative to single-phase nanoparticle tracers which enables their selective emulsion into oil. In this embodiment, the nanoparticles may be stable and colloidal in an aqueous solution given an absence of oil, but upon a change in the water to oil ratio in the fluid to a specific amount of oil in water, the nanoparticle may phase into the oil phase and remain stable in that phase.

Additionally, the nanoparticles can function as active tracers that can undergo a conformational change under including but not limited to the following conditions: a specific environmental temperature, or a specific environmental pressure, a specific concentration of ions and salinity, or a specific oil-to-water ratio in the formation. In this arrangement, the tracer particles can be functionalized with chemical groups that confer particle miscibility in both phases and increase retention rates of tracer nanoparticles in the reservoir matrix. These functional groups can be adhered to the external coating of the nanoparticle using the same mechanism as the original zwitterionic polymer groups, but have a different function when the particles undergo environmental changes. Examples of environmental changes causing a conformational change in the active tracer can include but are not limited to: variations in the proppant type and concentration of the proppant, variations in formation characteristics such as but not limited to changes in the fracture geometry and pore size of the subterranean rock, presence, absence, or concentration of fluid wetting agents, and variations in the surface area of the formation that comes into contact with the nanoparticles.

In one embodiment, passive tracer nanoparticles can be mixed with a stimulating fluid and injected at different fracture sites, or subterranean regions, during plug-and- perf operations. After completion and after the removal of frac plugs, the concentration of the nanoparticles can be determined in the produced water, giving statistics in a stage-by-stage manner regarding the success, failure, or varied degree of success of the plug and perf operation. Determining the success of the operation can include but is not limited to determining the extent and distance of the perforations, the extent and estimated distance of the fracturing channels, and determination of the amount of proppant remaining in a specific stage.

In another embodiment, passive and partitioning tracers previously discussed can be combined into the same stage, which allows for the generation of different statistics through the calculation of their concentration in the flowback fluid. These statistics can include the determination of residual oil saturation in one or multiple subterranean regions. This is achieved by differentially detecting the concentration of the two tracers as they flow in the produced fluid as well as the calculation of the time delay between their arrival at the detection device. The relative flow rates, breakthrough volumes, differentiated concentrations, and time delay dilation will enable the generation of statistics on different residual oil saturations of the specific stage that was tested.

In another embodiment, passive and active tracers previously discussed can be combined into the same stage, which allows for alternate statistics to be calculated using a similar concentration and time delay calculation. The statistics generated by this type of test can include but are not limited to the differential pressure in the wellbore versus the fracturing channels, the stability of the proppant in the formation, differential temperatures that may result in differences in hydrocarbon chain length in the produced hydrocarbons, and calculated fluid wetting properties.

In another embodiment, the nanoparticles can also be used in two or more separate horizontal wells located in a similar geographical region to test or confirm

In another embodiment, the nanoparticles can be used during other stimulation techniques, in addition to hydraulic fracturing, for oil and gas reservoir production including but not limited to water-flooding, gasification, and matrix acidization. During enhanced oil recovery operations, techniques such as waterflooding and gasification make use of additional stimulants to increase fluid movement in the subterranean region or regions of choice, in an effort to increase hydrocarbon production. Nanoparticle tracers can be used to test and determine the efficacy of these treatments. For example, nanoparticles injected in aqueous solution, during a waterflooding operation in an oilfield, can be detected at the producer wellbore after the nanoparticles have moved throughout the reservoir.

In another embodiment, the use of passive nanoparticle tracers in an interwell tracer test to flow precisely with the water front during a waterflooding enhanced oil recovery technique can produce statistics including but not limited to: the time between water injection and water breakthrough in the production well, and fluid velocities in differential areas in a subterranean reservoir. In another embodiment, the use of passive nanoparticle tracers in a single well tracer test can produce statistics regarding the movement of fluid in a wellbore. In another embodiment, the use of partitioning tracers in an interwell tracer test can produce statistics regarding residual oil saturation in differentiated areas in an underground oil reservoir. As the partitioning tracer flows from an injection well to the reservoir containing hydrophobic groups including oil, the partitioning tracer can experience phase changes. When the particle concentrations are detected at the wellbore, the ratio of particles in oil to particles in the aqueous phase can determine statistics regarding the ongoing operation of the enhanced oil recovery technique.

In some embodiments, the tracer nanoparticles can adhere to the surface of a proppant particle, including but not limited to: sands, coated sands and other silicates, ceramics, other structurally-ordered particles, and other injected particulates. These proppant particles can range in size from 200 nm to 20 mm, or from 200 nm to 2 mm. In this embodiment, the nanoparticle tracers can be used to determine the effectiveness of a proppant in one or multiple stages during hydraulic fracturing or enhanced oil recovery. Additionally, the nanoparticle tracers can be used to determine the flow of specific proppants in one or multiple subterranean regions. In one embodiment, the tracer nanoparticles are covalently bonded to the surface of the proppant particle. In another embodiment, the tracer nanoparticles can adhere to the surface of proppant particle but are effectively released from the surface of the proppant particles in the presence of an environmental change, including but not limited to: changes in temperature, changes in pressure, changes in pH, changes in salinity, changes as a result of the increase of concentration of a particulate such as an ion, and changes in fluid velocity.

In another embodiment, the nanoparticles can be used to trace water or brine reservoirs used in power generation in enhanced geothermal systems plants. Enhanced geothermal systems operations rely on the flow of fluid deep underground around formations, including hot dry rocks, that will heat the fluid. As the fluid moves from an injector well and towards a producer well, it heats up, and power is generated through the thermodynamic difference in the injected and produced fluids. The tracer nanoparticles can be used to track the flow of fluid from the injector well to the producer well, which can generate statistics including but not limited to: fluid flow rates, percentage of fluid recovered, efficacy of producer well placement, estimated fluid recovery over time, fluid channel pore size, and subterranean formation permeability.

### Alternative Embodiments

MnO Nanoparticles Capped with other Lactams—While the embodiments described hereinabove have been focused on capping MnO nanoparticles with pyrrolidine-2-one, it is reasonably believed that other lactams of similar sizes will provide other embodiments of capped MnO nanoparticles with similar properties. Such embodiments are also within the scope of the invention. Such alternative embodiments may be synthesized, for example using other lactams including, but not limited to single ring lactams such as azetidin-2-one (β-lactam), piperidin-2-one (δ-lactam) and azepan-2-one (ε-lactam).

Structural Variability—The MnO nanoparticles may have some variations in structure while retaining favorable properties for MRI. In some embodiments, the nanoparticles have hydrolyzed and/or polymerized moieties generated from the lactam via a rearrangement and formation of an oxime. In other embodiments, moieties of the nanoparticles are generated via tautomerization of the lactam to a lactim. In some embodiments, the single ring lactam compound includes one or more substituents at one or more of its aliphatic carbons. In other embodiments the substituents are provided with functional groups to allow conjugation to targeting moieties.

Targeting Moieties—Embodiments of the MnO capped nanoparticles described herein may be further provided with targeting moieties to direct them to desired locations within the body. Accordingly, targeting moieties may be conjugated using conventional methods, such as maleimide conjugation, for example, to appropriate locations on the lactam, such as to a substituent on one of the aliphatic carbons of the lactam for example. Examples of targeting moieties include, but are not limited to, an antibody, an antibody fragment, a nucleic acid, a small molecule recognized by a receptor, a protein or a peptide. Hellebust et al. have reviewed strategies for preparing targeted optical contrast agents.⁶⁶

Nanoparticle size—As the nanoparticles are paramagnetic at room temperature, their size does not strongly affect their magnetic properties. As such, embodiments of the MnO capped nanoparticles described herein may be further provided with nanoparticles with average diameters ranging from ˜2 nm to 100 nm.

Nanoparticle shape—As the nanoparticles are paramagnetic at room temperature, their shapes do not strongly affect their magnetic properties. As such, embodiments of the MnO capped nanoparticles described herein may be further provided with nanoparticles with cubic, plate, rhombohedral, multipod (e.g. octapod), nanorod, nanowire, or irregular shape.

### Equivalents and Scope

Other than described herein, or unless otherwise expressly specified, all numerical ranges, amounts, values and percentages, such as those for amounts of materials, elemental contents, times and temperatures, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs.

While this invention has been particularly shown and described with references to embodiments thereof, it will be understood by those skilled in the art that various changes in form and details may be made therein without departing from the scope of the invention encompassed by the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

It is also noted that the term “comprising” is intended to be open and permits but does not require the inclusion of additional elements or steps. When the term “comprising” is used herein, the term “consisting of” is thus also encompassed and disclosed. Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. Where the term “about” is used, it is understood to reflect +/−10% of the recited value. In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein.

### REFERENCES

1. R. Serrano García, S. Stafford and Y. K. Gun'ko, Appl. Sci., 2018, 8, 172.
2. Q. Le Trequesser, H. Seznec and M.-H. Delville, Nanotechnol. Rev., 2013, 2, 125-169.
3. K. Yan, P. Li, H. Zhu, Y. Zhou, J. Ding, J. Shen, Z. Li, Z. Xu and P. K. Chu, RSC Adv., 2013, 3, 10598-10618.
4. J. Gao, H. Gu and B. Xu, Acc. Chem. Res., 2009, 42, 1097-1107.
5. F. Wang, X. Chen, Z. Zhao, S. Tang, X. Huang, C. Lin, C. Cai and N. Zheng, J. Mater. Chem., 2011, 21, 11244-11252.
6. D. H. Carr and D. G. Gadian, Clin. Radiol., 1985, 36, 561-568.
7. Y. Lu, B. He, J. Shen, J. Li, W. Yang and M. Yin, Nanoscale, 2015, 7, 1606-1609.
8. C. Borgohain, K. K. Senapati, D. Mishra, K. C. Sarma and P. Phukan, Nanoscale, 2010, 2, 2250-2256.
9. D. Koktysh, V. Bright and W. Pham, Nanotechnology, 2011, 22, 275606.
10. L. Sun, Y. Zang, M. Sun, H. Wang, X. Zhu, S. Xu, Q. Yang, Y. Li and Y. Shan, J. Colloid Interface Sci., 2010, 350, 90-98.
11. D. H. Ortgies, L. de la Cueva, B. del Rosal, F. Sanz-Rodríguez, N. Fernández, M. C. Iglesias-de la Cruz, G. Salas, D. Cabrera, F. J. Teran and D. Jaque, ACS Appl. Mater. Interfaces, 2016, 8, 1406-1414.
12. E. M. Haacke, R. W. Brown, M. R. Thompson, R. Venkatesan et al., Magnetic resonance imaging: physical principles and sequence design, Wiley-liss New York: 1999, vol. 82.
13. M. Chen and M. Yin, Prog. Polym. Sci., 2014, 39, 365-395.
14. S. Walia, S. Sharma, P. M. Kulurkar, V. Patial and A. Acharya, Int. J. Pharm., 2016, 498, 110-118.
15. J. Wan, X. Meng, E. Liu and K. Chen, Nanotechnology, 2010, 21, 235104.
16. A. P. Koretsky and A. C. Silva, NMR Biomed., 2004, 17, 527-531.
17. A. C. Silva, J. H. Lee, I. Aoki and A. P. Koretsky, NMR Biomed., 2004, 17, 532-543.
18. C. A. Massaad and R. G. Pautler, Magnetic Resonance Neuroimaging, Springer, 2011, pp. 145-174.
19. J. Crossgrove and W. Zheng, NMR Biomed., 2004, 17, 544-553.
20. Y.-w. Jun, J.-H. Lee and J. Cheon, Angew. Chem. Int. Ed., 2008, 47, 5122-5135.
21. A. P. Koretsky and A. C. Silva, NMR Biomed., 17, 527-531.
22. A. W. Varnes, R. B. Dodson and E. L. Wehry, J. Am. Chem. Soc., 1972, 94, 946-950.
23. S. Lin, H. Cheng, Q. Ouyang and H. Wei, Anal. Methods, 2016, 8, 3935-3940.
24. H. B. Y. Wei, N. Michael, T. Aaron, C. John, R. Thomas, L. Mark, Z. Yu, W. S. Yee, B. Kishore, S. A. M., L. Xu and W. John, Adv. Healthcare Mater., 5, 721-729.
25. Y. Hong, Z. Yeming, H. He, D. Xiaoxia, Z. Cuixia, S. Xiangyang, W. Huixia and Y. Shiping, Adv. Funct. Mater., 20, 1733-1741.
26. T. D. Schladt, K. Schneider, M. I. Shukoor, F. Natalio, H. Bauer, M. N. Tahir, S. Weber, L. M. Schreiber, H. C. Schroder, W. E. G. Muller and W. Tremel, J. Mater. Chem., 2010, 20, 8297-8304.
27. C. Shao, S. Li, W. Gu, N. Gong, J. Zhang, N. Chen, X. Shi and L. Ye, Anal. Chem., 2015, 87, 6251-6257.
28. Z. Yizhe, M. Jing, S. Xianyong and T. Yang, Adv. Opt. Mater., 4, 1115-1123.
29. Y. Zhan, W. Zhan, H. Li, X. Xu, X. Cao, S. Zhu, J. Liang and X. Chen, Molecules, 2017, 22, 2208.
30. R. Thurer, D. Bognolo, A. Vargas, J. Isch and G. Kaiser, J. Thorac. Cardiovasc. Surg., 1974, 68, 962-968.
31. M. J. Baek, J. Y. Park, W. Xu, K. Kattel, H. G. Kim, E. J. Lee, A. K. Patel, J. J. Lee, Y. Chang, T. J. Kim, J. E. Bae, K. S. Chae and G. H. Lee, ACS Appl. Mater. Interface, 2010, 2, 2949-2955.
32. Z. Li, H. Chen, H. Bao and M. Gao, Chem. Mater., 2004, 16, 1391-1393.
33. T. Wang, Z. Peng, Y. Wang, J. Tang and G. Zheng, Sci. Rep., 2013, 3, 2693.
34. A. E. Berkowitz, G. F. Rodriguez, J. I. Hong, K. An, T. Hyeon, N. Agarwal, D. J. Smith and E. E. Fullerton, Phys. Rev. B, 2008, 77, 024403.
35. G. Salazar-Alvarez, J. Sort, S. Suriňach, M. D. Baró and J. Nogúes, J. Am. Chem. Soc., 2007, 129, 9102-9108.
36. T. Özkaya, A. Baykal and M. S. Toprak, Cent. Eur. J. Chem., 2008, 6, 465.
37. M. Ghosh, K. Biswas, A. Sundaresan and C. N. R. Rao, J. Mater. Chem., 2006, 16, 106-111.
38. W. S. Seo, H. H. Jo, K. Lee, B. Kim, S. J. Oh and J. T. Park, Angew. Chem. Int. Ed., 2004, 43, 1115-1117.
39. G. H. Lee, S. H. Huh, J. W. Jeong, B. J. Choi, S. H. Kim and H.-C. Ri, J. Am. Chem. Soc., 2002, 124, 12094-12095.
40. S. Guoshan, L. Yannan, Z. Zhongcheng, Z. Heying, Q. Jinping, H. Changcheng and W. Huiliang, Macromol. Rapid Commun., 36, 278-285.
41. Z. Y. Wang and Z. Yongming, J. Polymer Sci. A: Polymer Chem., 55, 560-574.
42. Y. Jun-Jie, W. Zhong-Kai, L. Xiang-Song, H. Chun-Yan, L. Hao-Jun, P. Cai-Yuan and Y. Ye-Zi, Adv. Mater., 24, 5617-5624.
43. W. Te-Haw, L. Ching-Ping, C. Chih-Te and L. Shu-Yi, Chem. Eur. J., 19, 11672-11675.
44. C. A. Schneider, W. S. Rasband and K. W. Eliceiri, Nat. Met., 2012, 9, 671.
45. T. Mosmann, J. Immunol. Methods, 1983, 65, 55-63.
46. Z. Li, Q. Sun and M. Gao, Angew. Chem. Int. Ed., 2005, 44, 123-126.
47. X. Lu, M. Niu, R. Qiao and M. Gao, J. Phys. Chem. B, 2008, 112, 14390-14394.
48. X. Lu, M. Niu, R. Qiao and M. Gao, J. Phys. Chem. B, 2008, 112, 14390-14394.
49. X. Lu, M. Niu, C. Yang, L. Yi, R. Qiao, M. Du and M. Gao, Sci. Bull., 2010, 55, 3472-3478.
50. T. D. Schladt, T. Graf and W. Tremel, Chem. Mater., 2009, 21, 3183-3190.
51. M. Lei, C. Fu, X. Cheng, B. Fu, N. Wu, Q. Zhang, A. Fu, J. Cheng, J. Gao and Z. Zhao, Adv. Funct. Mater., 2017, 27, 1700978-n/a.
52. C. E. Carraher, Journal of Chemical Education, 1978, 55, 51.
53. J. Fei, L. Sun, C. Zhou, H. Ling, F. Yan, X. Zhong, Y. Lu, J. Shi, J. Huang and Z. Liu, Nanoscale research letters, 2017, 12, 23.
54. H. Na, J. Lee, K. An, Y. Park, M. Park, I. Lee, D.-H. Nam, S. Kim, S.-H. Kim, S.-W. Kim, K.-H. Lim, K.-S. Kim, S.-O. Kim and T. Hyeon, Angew. Chem. Int. Ed., 2007, 119, 5493-5497.
55. Lee, ACS Appl. Mater. Interface, 2010, 2, 2949-2955.
56. J. Park, D. Bang, E. Kim, J. Yang, E.-K. Lim, J. Choi, B. Kang, J.-S. Suh, H. S. Park and Y.-M. Huh, Eur. J. lnorg. Chem., 2012, 5960-5965.
57. J. Huang, J. Xie, K. Chen, L. Bu, S. Lee, Z. Cheng, X. Li and X. Chen, Chem. Commun., 2010, 46, 6684-6686.
58. T. Kim, E. Momin, J. Choi, K. Yuan, H. Zaidi, J. Kim, M. Park, N. Lee, M. T. McMahon and A. Quinones-Hinojosa, J. Am. Chem. Soc., 2011, 133, 2955-2961.
59. F. J. Douglas, D. A. MacLaren, F. Tuna, W. M. Holmes, C. C. Berry and M. Murrie, Nanoscale, 2014, 6, 172-176.
60. P. Chevallier, A. Walter, A. Garofalo, I. Veksler, J. Lagueux, S. Begin-Colin, D. Felder-Flesch and M.-A. Fortin, J. Mater. Chem. B, 2014, 2, 1779-1790.
61. N. Chen, C. Shao, S. Li, Z. Wang, Y. Qu, W. Gu, C. Yu and L. Ye, J. Colloid Interface Sci., 2015, 457, 27-34.
62. N. Chen, C. Shao, Y. Qu, S. Li, W. Gu, T. Zheng, L. Ye and C. Yu, ACS applied materials & interfaces, 2014, 6, 19850-19857.
63. J. Lai, T. Wang, H. Wang, F. Shi, W. Gu and L. Ye, Microchim. Acta, 2018, 185, 244.
64. S. Song, Y. Lin, Z. Shu, H. Zheng, J. Qiao, C. He and H. Wang, Macromol. Rapid Commun. 2015, 36, 278-285.
65. U.S. Patent Publication No. 20160051708.
66. A. Hellebust and R. Richards-Kortum, Nanomedicine (Lond.) 2012, 7, 429-445.
67. PCT Publication No. WO2017136641.
68. PCT Publication No. WO2015200789.
   Each reference in this list is incorporated herein by reference in its entirety.

1. A manganese oxide nanoparticle for use in characterizing medical conditions or geological formations, the nanoparticle capped with a lactam compound and/or a hydrolyzed and polymerized product thereof.

2. The nanoparticle of claim 1, wherein the manganese oxide is MnO.

3. The nanoparticle of claim 1, wherein the lactam compound is azetidin-2-one (β-lactam, pyrrolindin-2-one (γ-lactam), piperidin-2-one (δ-lactam) or azepan-2-one (ε-lactam).

4. The nanoparticle of claim 1, wherein the hydrolyzed and/or polymerized product is generated via a rearrangement and formation of an oxime or via tautomerization to a lactim.

5. The nanoparticle of claim 1, wherein the single ring lactam compound includes one or more substituents at one or more of its aliphatic carbons.

6. The nanoparticle of claim 1, wherein the lactam compound is conjugated to a targeting moiety.

7. The nanoparticle of claim 6, wherein the targeting moiety is an antibody, an antibody fragment, a nucleic acid, a small molecule recognized by a receptor, a protein or a peptide.

8. A synthetic process for preparing a bifunctional manganese oxide nanoparticle, the process comprising:
a) mixing a Mn(II) transition metal complex with a lactam compound solvent to generate a mixture;
b) heating the mixture; and
c) adding an anti-solvent to the mixture to precipitate the nanoparticle.

9. The process of claim 8, wherein the Mn(II) transition metal complex is Mn(acac)₂.

10. The process of claim 8, wherein the manganese oxide is MnO.

11. The process of claim 8, wherein the lactam compound is azetidin-2-one (β-lactam, pyrrolindin-2-one (γ-lactam), piperidin-2-one (δ-lactam) or azepan-2-one (ε-lactam).

13. The process of claim 8, further comprising forming a hydrolyzed and/or polymerized product via a rearrangement and formation of an oxime or via tautomerization to a lactim.

12. The process of claim 8, wherein the lactam compound includes one or more substituents at one or more of its aliphatic carbons.

13. The process of claim 8, wherein the lactam compound is conjugated to a targeting moiety.

14. The process of claim 13, wherein the targeting moiety is an antibody, an antibody fragment, a nucleic acid, a small molecule recognized by a receptor, a protein or a peptide.

15. A composition comprising the nanoparticle of claim 1 dispersed in a hydrophilic solvent or a hydrophobic solvent.

16. A process for characterizing one or more subterranean regions comprising:
injecting a nanoparticle as recited in claim 1 into one or more discrete subterranean regions, and
detecting fluorescence and/or magnetism of the nanoparticle in produced fluid, wherein the produced fluid comprises the injected fluid and a formation fluid from one or multiple subterranean regions.

17. The process of claim 16, further comprising dispersing an aqueous suspension of the nanoparticle in a drilling fluid, a fracturing fluid, or an injection fluid prior to the injecting step.

18. The process of claim 16, wherein the detecting step comprises optically detecting the nanoparticle in the produced fluid using an in-flow fluorescent measurement technique.

19. The process of claim 18, wherein the optically detecting step is performed via photometer, fluorometer, spectrofluorometer, Raman spectrometer or a combination thereof.

20. The process of claim 16, wherein the nanoparticles are adhered to proppant particles or chemicals.

21. The process of claim 20, wherein the proppant particles are sand, silicates, resins, surfactants, or ceramics.

22. The process of claim 20, wherein the chemicals are used during stimulation, completion, and production.

23. The process of claim 16, wherein the detecting step provides data that permits quantification of breakthrough, or quantification of stage-specific hydrocarbon production, or a combination thereof.

24. A process for determining a property of a subsurface formation, the process comprising:
injecting a fluid comprising the nanoparticle of claim 1 into the subsurface formation;
applying a variable magnetic field to the subsurface formation;
detecting a magnetic response signal from the subsurface formation; and
processing the magnetic response signal to obtain a property of the subsurface formation.

25. The process of claim 24, wherein the applying and detecting steps occur before the injecting step, and the magnetic response signal of the subsurface formation is processed to obtain a reference property of the subsurface formation.

26. The process of claim 24, wherein processing the magnetic response signal comprises comparing the reference property of the subsurface formation to the sample property of the subsurface formation.

27. The process of claim 24, wherein the fluid is injected into the subsurface formation from a wellbore and the variable magnetic field is applied to the subsurface formation from the same wellbore.

28. The process of claim 24, wherein the variable magnetic field applied to the subsurface formation is supplied by a logging tool that is inserted into the subsurface formation.

29. The process of claim 24, wherein processing the magnetic response signal comprises determining the concentration, spatial resolution, penetration depth, or combinations thereof, of the plurality of superparamagnetic particles in the subsurface formation.

30. The process of claim 24, wherein the property of the subsurface formation comprises porosity, solid content, water content, fluid content, fluid composition, hydrocarbon location, hydrocarbon content, contaminant location, contaminant content, permeability, or combinations thereof.
